(19) United States
(12) Patent Application Publication
(10) Pub. No.: US 2021/0068358 A1
(43) Pub. Date: Mar. 11, 2021

(54) CULTIVATION SYSTEM HAVING CULTIVATION BOX AND CONTROLLING METHOD THEREOF

(71) Applicant: SAMSUNG ELECTRONICS CO., LTD., Suwon-si (KR)

(72) Inventors: Seungbin IM, Suwon-si (KR); Taewan KIM, Suwon-si (KR); Yujin NA, Suwon-si (KR); Sohmin AHN, Suwon-si (KR); Kyoungwoon HAHM, Suwon-si (KR)

(21) Appl. No.: 16/928,358

(22) Filed: Jul. 14, 2020

(30) Foreign Application Priority Data
Sep. 11, 2019 (KR) 10-2019-0113145

(51) Int. Cl. A01G 31/06; G06K 9/00; G06T 7/00; A01G 9/029; A01G 7/04

(52) U.S. Cl. CPC A01G 31/06; G06K 9/00664; G06T 7/0002; G06K 2209/17; A01G 7/045; G06T 2207/30188; A01G 9/0293

(57) ABSTRACT

Disclosed a plant cultivation system including: a replaceable cultivation box including a housing, and identification information of the cultivation box, and an electronic device configured to acquire the identification information from the cultivation box, detect state information about an inside of the cultivation box or around the cultivation box using a sensor, and spray liquid into the cultivation box based on the identification information and the state information.

### CROSS-REFERENCE TO RELATED APPLICATION

This application is based on and claims priority under 35 U.S.C. § 119 to Korean Patent Application No. 10-2019-0113145, filed on Sep. 11, 2019, in the Korean Intellectual Property Office, the disclosure of which is incorporated by reference herein its entirety.

### BACKGROUND

### 1. Field

The disclosure relates to a cultivation system for cultivating a plant.

### 2. Description of Related Art

As a standard of living has improved, people have become highly interested in hazard of foods in terms of diet. Thus, desire to directly cultivate crops has increased. Accordingly, a plant cultivation device that may be installed indoors to directly cultivate vegetables has been developed.

For example, the plant cultivation device has a plant cultivation unit having a predetermined number of port receiving grooves and installed above a nutrient solution container containing a nutrient solution therein, and a predetermined number of ports received in the port receiving grooves respectively, wherein each port contains a culture medium therein for supporting a root of a plant. The culture medium is connected to a wick that is immersed in the nutrient solution of the nutrient solution container such that the nutrient solution is fed to the culture medium through the wick.

Alternatively, a plant cultivation device using an aeroponics scheme has been developed. In the plant cultivation device using the aeroponics scheme, a root of a plant is exposed to air. A mist or other liquid spray scheme is used to supply moisture or a nutrient solution to the root. The plant cultivation device using the aeroponics scheme may include a housing having a space defined therein for exposing the root of the plant to the air, and forming a mist made of the moisture or the nutrient solution in the air or spraying the moisture or the nutrient solution.

The device may further include sensors that detect information about an environment such as temperature, amount of light, and humidity. The plant cultivation device may control operations of components of the plant cultivation device so that the environment suitable for plant growth is created, based on sensing results from the sensors that detect the information about the environment.

In order to cultivate a plant in a plant cultivation device and then cultivate another plant therein, a previous culture medium for cultivating the former plant should be removed and an inside of a housing where a root of the former plant was accommodated should be cleaned. Therefore, inconvenience of the cleaning the inside of the housing may occur whenever each plant cultivation is completed.

A user has a desire to cultivate various plants in a single plant cultivation device. However, an environment condition to be created varies according to a type of a plant. Thus, it is not easy to create an appropriate environment condition according to a type of a plant being cultivated.

A seed or a seedling of a plant to be cultivated in the plant cultivation device may be provided to a user. However, a normal product is not provided to the user when the plant may not grow normally due to characteristics of the seed or the seedling.

The above information is presented as background information only to assist with an understanding of the disclosure. No determination has been made, and no assertion is made, as to whether any of the above might be applicable as prior art with regard to the disclosure.

### SUMMARY

Embodiments of the disclosure address at least the above-mentioned problems and/or disadvantages and to provide at least the advantages described below.

In accordance with an example embodiment of the disclosure, an electronic device may include: a support configured to support a cultivation box for plant cultivation, a nozzle configured to be inserted into the cultivation box based on the cultivation box being seated on the support, a liquid supplier configured to spray liquid into the cultivation box through the nozzle, a sensor configured to detect state information inside or around the cultivation box, a recognition circuitry configured to acquire identification information identifying the cultivation box from the cultivation box based on the cultivation box being seated on the support, and a processor connected to the liquid supplier, the sensor, and the recognition unit.

The processor may identify an operation state of the driver based on the state information and the identification information based on the cultivation box being seated on the support, and control the liquid supplier to spray the liquid into the cultivation box based on the identified operation state.

In accordance with another example embodiment of the disclosure, a cultivation box for plant cultivation may include: an identifier comprising readable identification information configured to provide identification information of the cultivation box, and a housing having an inner space blocked from an outside. The housing may include a culture medium container provided in a top of the housing and accommodating a culture medium in the container, a nozzle receiving portion accommodating a nozzle based on the cultivation box being seated on an electronic device having the nozzle, and a sensor receiving portion accommodating a sensor of the electronic device.

In accordance with another example embodiment of the disclosure, a plant cultivation system may include: a replaceable cultivation box including a housing, and identification information, and an electronic device configured to: acquire the identification information from the cultivation box, detect state information about an inside of the cultivation box or around the cultivation box using a sensor, and spray liquid into the cultivation box based on the identification information and the state information.

Other aspects, advantages, and salient features of the disclosure will become apparent to those skilled in the art from the following detailed description, which, taken in conjunction with the annexed drawings, discloses various example embodiments of the disclosure.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a perspective view illustrating an example cultivation system including an electronic device and a cultivation box according to an embodiment;

FIG. 2 is a diagram illustrating an example cultivation system including an electronic device and a cultivation box according to an embodiment;

FIG. 3 shows a cross-sectional view illustrating an example cultivation box according to an embodiment;

FIG. 4 is a perspective view illustrating an example appearance of a cultivation box according to an embodiment;

FIG. 5 diagram illustrating an example structure in which a cultivation box is seated on an electronic device according to an embodiment;

FIG. 6 is a diagram illustrating an example state in which an electronic device sprays liquid into a cultivation box according to an embodiment;

FIG. 7 is a diagram illustrating an example state in which an electronic device stops spraying liquid according to an embodiment;

FIG. 8 is a block diagram illustrating an example electronic device in a network environment according to various embodiments;

FIG. 9 is a block diagram illustrating an example configuration of an electronic device according to an embodiment;

FIG. 10 is a flowchart illustrating an example operation of an electronic device according to an embodiment;

FIG. 11 is a diagram illustrating an example screen output according to an embodiment;

FIG. 12 is a flowchart illustrating an example process of monitoring a growth state using an electronic device plant according to an embodiment; and

FIG. 13 is a signal flow diagram illustrating an example operation of a cultivation system including a management server according to an embodiment.

### DETAILED DESCRIPTION

Hereinafter, various example embodiments of the disclosure may be described with reference to accompanying drawings. Accordingly, those of ordinary skill in the art will recognize that various modifications, equivalents, and/or alternatives on the various example embodiments described herein can be variously made without departing from the scope and spirit of the disclosure.

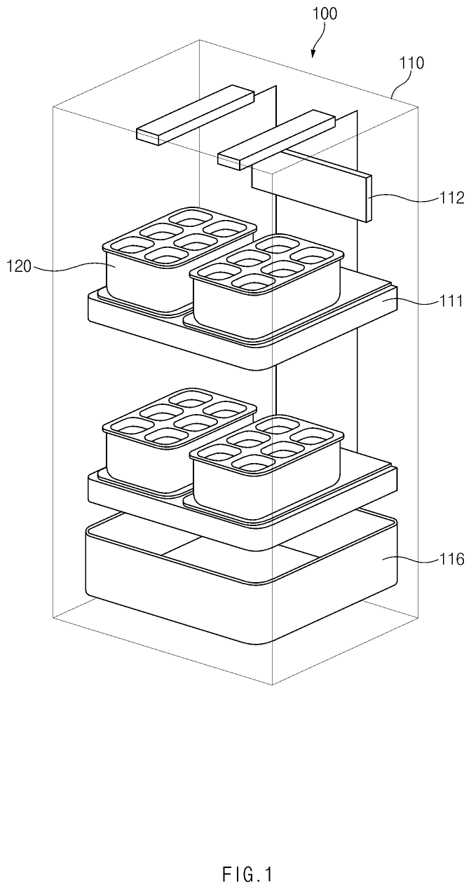

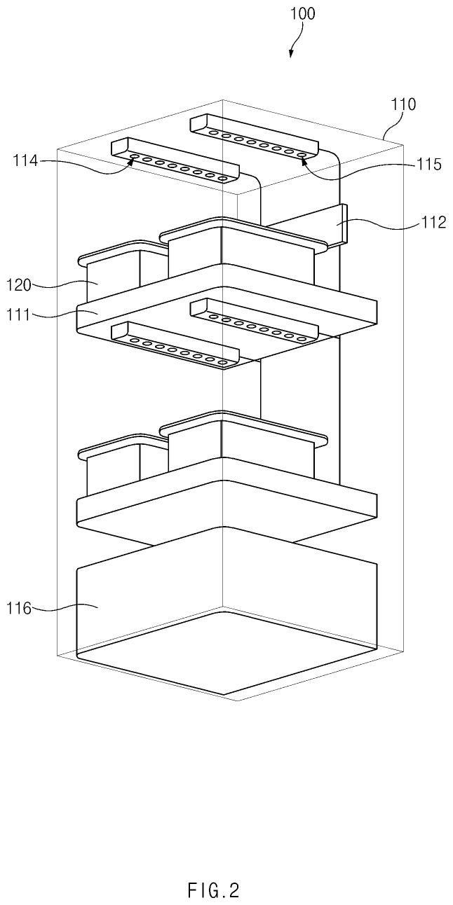

FIG. 1 and FIG. 2 are perspective views illustrating an example cultivation system 100 including an electronic device 110 according to an example embodiment.

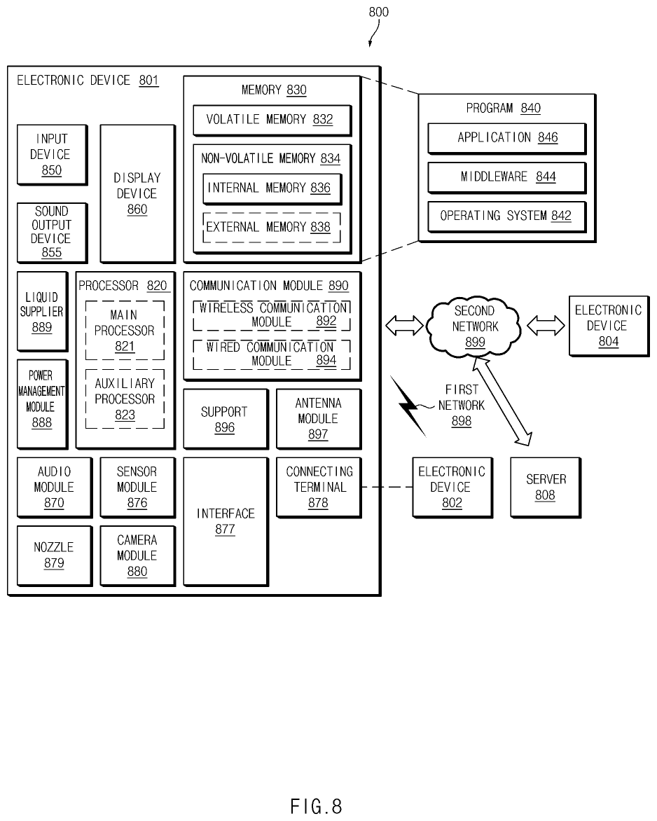

According to an example embodiment, the electronic device 110 may include a support 111 for supporting a cultivation box 120 in a housing thereon, a camera 114 configured to photograph at least one surface of the cultivation box 120 seated on the support 111, a lamp 115 (e.g., a LED lamp) configured to irradiate light to the cultivation box 120 seated on the support 111, a controller (e.g., including processing circuitry) 112 configured to control components of the electronic device 110 such as the camera 114 and the lamp 115, and a liquid storage 116 for storing a liquid (e.g., water or nutrient solution) therein. The controller 112 may include a memory (e.g., a memory 830 in FIG. 8) for storing instructions and a processor (e.g., a processor 820 in FIG. 8, e.g., including processing circuitry) for executing the instructions. The processor may include various processing circuitry and control components connected directly or indirectly to the processor by executing the instructions. In accordance with the disclosure, it may be understood that an operation of the electronic device 110 is performed based on the processor executing the instructions and thus controlling the components of the electronic device 110.

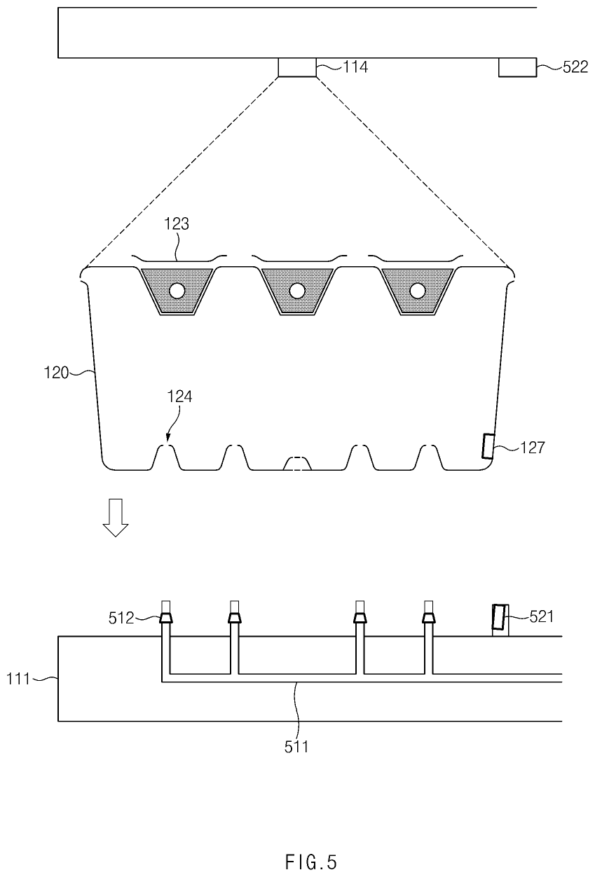

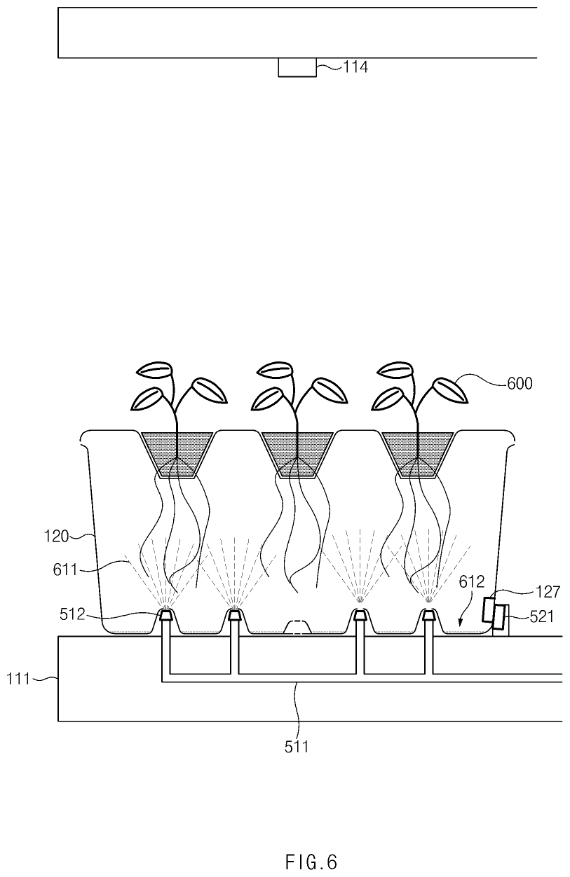

Further, the electronic device 110 may include a nozzle (e.g., a nozzle 512 of FIG. 5 and FIG. 6) from which liquid is sprayed. The cultivation box 120 may be separate from the electronic device 110 such that the cultivation box 120 is replaceable. The nozzle may be configured to spray the liquid into the cultivation box 120 as the cultivation box 120 is seated on the support 111. The electronic device 110 may include a driver (e.g., a pump) that supplies liquid of the liquid container 116 to the nozzle through a pipe so that the nozzle sprays the liquid. The controller 112 may control an operation of the driver and thus spray the liquid into the cultivation box 120 through the nozzle.

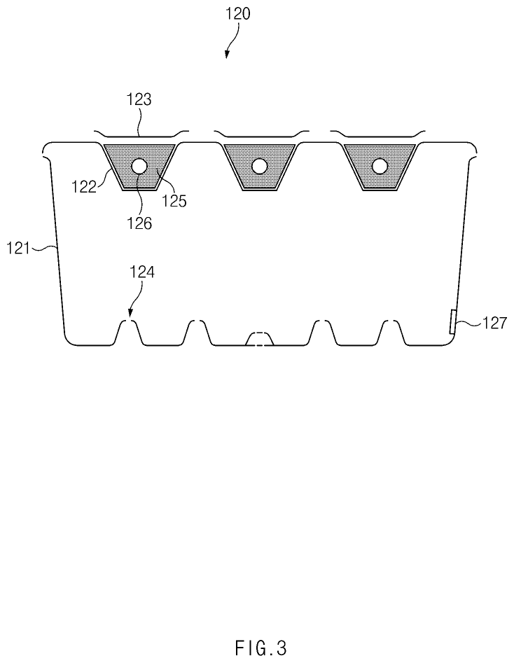

FIG. 3 is a cross-sectional view illustrating a vertical cross-section of an example cultivation box 120 according to an example embodiment.

According to an example embodiment, the cultivation box 120 may include a housing 121 comprising a rigid material. A culture medium container 122 accommodating a culture medium 125 therein. The culture medium container 122 may be formed in a top of the housing 121. The culture medium 125 may refer, for example, to a substance including nutrients necessary for plant culture. The culture medium 125 may include, for example, and without limitation, a solid culture medium, a liquid culture medium, or the like. In the culture medium 125, a seed 126 of a plant may be disposed.

According to an example embodiment, the cultivation box 120 may include an identifier providing means (e.g., including electronically and/or optically readable) identification information, which may be referred to hereinafter as an identifier). When the cultivation box 120 is placed in the cultivation system, for example, the cultivation system 100 of FIG. 1, the identifier may provide identification information to an electronic device, for example, the electronic device 110 of FIG. 1 or an electronic device 801 of FIG. 8 such that the electronic device identifies the cultivation box 120 based on the identification information. The identifier may include a configuration that allows the electronic device to directly read the identification information or a configuration that allows the electronic device to read a location of the identification information. For example, the identifier may include, for example, and without limitation, an image code marked on the cultivation box 120. The image code may include, for example, a one-dimensional code such as, for example, and without limitation, a bar code, or the like, and/or a two-dimensional code, for example, and without limitation, a QR code, or the like.

According to an example embodiment, the image code may be marked on one surface of a cultivation cover 123. When the image code is marked on one surface of the cultivation cover 123, the electronic device may obtain an image containing the image code captured using the camera, for example, the camera 114 of FIG. 2 as the cultivation box 120 is placed on the support, for example, the support 111 in FIG. 1. The electronic device may recognize the image code from the acquired image, and may obtain the identification information from the image code.

According to an example embodiment, the image code may be printed on the housing 121 such that the image code is screened with the cultivation cover 123 attached to the housing 121. When a user removes the cultivation cover 123 corresponding to the seed 126 to be cultivated, only the image code which has been screened with the removed cultivation cover 123 may be recognized using the camera.

A supplier for providing the cultivation box 120 may collect and reuse the cultivation box 120 that has been used. When providing the identification information using the image code marked on the cultivation box 120, the supplier may supply the cultivation box 120 that satisfies a need of a consumer for various kinds of seeds 126 by replacing a previous image code with a new image code in a printed manner when the cultivation box 120 is reused.

A plurality of image codes may be marked on various surfaces of the culture medium container 122, respectively. One image code including location information indicating a location of the culture medium container 122 receiving a corresponding seed 126 therein may be marked on the cultivation box 120.

According to an example embodiment, the identifier may include, for example, and without limitation, an RFID tag, or the like, recording the identification information. The RFID tag may be attached to the housing 121. When the RFID tag receives a RF signal, the RFID tag may transmit the RF signal carrying the identification information in response to the reception of the RF signal. However, the disclosure is not limited thereto. The identifier may be configured using other types of technical configurations capable of providing the identification information to the electronic device.

According to an example embodiment, the cultivation box 120 may include a nozzle receiving portion 124 for receiving the nozzle therein. For aeroponics, moisture or nutrient solution may, for example, be maintained in a form of mist inside the cultivation box 120. Thus, the housing 121 may be formed in a structure where the inside of the housing 121 is sealed from the outside when the nozzle is accommodated in the nozzle receiving portion 124.

According to an example embodiment, the cultivation box 120 may include a sensor receiving portion 127 that receives therein (or is connected to) a sensor of the electronic device so that the electronic device may detect state information about an environment of the cultivation box. For example, the sensor receiving portion 127 may be embodied, for example, and without limitation, as an electrode for sensing a vertical level of the liquid collected on a bottom of the housing 121 and inside the housing 121. The electronic device may have a wire to connect the electrode to the outside of the housing 121 and thus detect information about the vertical level of the liquid inside the housing 121. In another example, the sensor receiving portion 127 may be embodied as an opening into which a temperature sensor of the electronic device may be inserted.

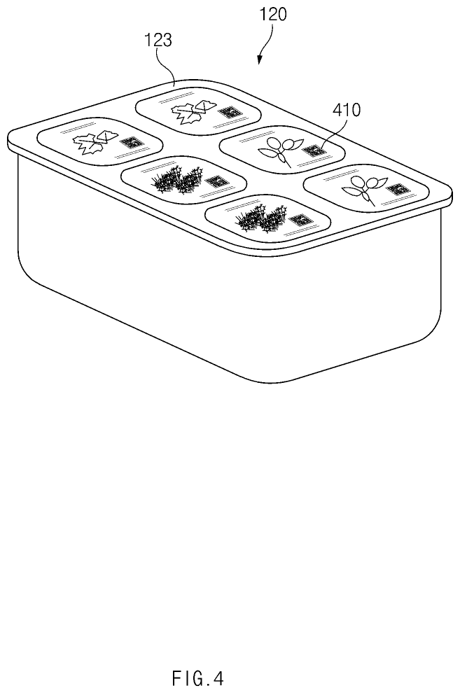

FIG. 4 is a diagram illustrating an example appearance of the cultivation box 120 according to an example embodiment.

According to an example embodiment, the cultivation cover 123 may be attached to a top of the cultivation box 120 to seal the cultivation box 120. The cultivation cover 123 may be configured to be easily removed therefrom by a user.

Referring to FIG. 4, a QR code 410 may be marked on the cultivation cover 123. The QR code 410 marked on each cultivation cover 123 may be associated with the identification information indicating a type of a plant seed accommodated in each cultivation box 120.

FIG. 5 is a diagram illustrating an example of a structure in which the cultivation box 120 is seated on the electronic device, for example, the electronic device 110 in FIG. 1 and the electronic device 801 in FIG. 8 according to an example embodiment.

According to an example embodiment, the support 111 of the electronic device may include the nozzle 512 that may receive the liquid through a pipe 511. Although not shown in FIG. 5, the pipe 511 may be connected to the driver, for example, a pump that allows the liquid to be sprayed through the nozzle 512. A combination of the driver and the pipe 511 may, for example, be referred to as a liquid supplier.

When the cultivation box 120 is seated on the support 111, the nozzle 512 may be accommodated in the nozzle receiving portion 124 of the cultivation box 120. When the driver supplies the liquid to the nozzle 512 in a state where the nozzle 512 is accommodated in the nozzle receiving portion 124, the liquid may be sprayed from the nozzle 512 into the cultivation box 120.

The camera 114 of the electronic device may be configured to photograph an outside of the cultivation box 120 in a state where the cultivation box 120 is seated on the support 111. According to an example embodiment, the electronic device may acquire the identification information for identifying the cultivation box 120 using the camera 114. For example, the electronic device may obtain information about a type of a seed contained in the culture medium container of the cultivation box 120.

According to an embodiment, when the cultivation cover 123 of the cultivation box is removed therefrom, the electronic device may control operations of the components of the electronic device to create a suitable environment for growth of the seed 126 in the culture medium container which has been previously sealed with the cultivation cover 123 as currently removed.

According to an example embodiment, the electronic device may identify a plurality of image codes. When the number of the image codes recognized from the image captured through the camera is reduced, the electronic device may determine that a portion of the cultivation cover 123 on which the image codes are marked is removed. The seed 126 may germinate when the cultivation cover 123 is removed and the user supplies moisture to the culture medium 125. Thus, the electronic device may control the operations of the components of the electronic device to create an environment suitable for the growth of the germinated seed 126. In this connection, the electronic device may control the operations of the components of the electronic device based on the obtained identification information. For example, when the electronic device obtains a QR code having identification information indicating that the seed 126 is basil and a QR code having identification information indicating that the seed 126 is rosemary are obtained, and, then, obtains only the QR code indicating identification information indicating that the seed 126 is rosemary from an image re-photographed using the camera, the electronic device may determine that the cultivation cover 123 having the QR code indicating the basil marked thereon has been removed. Accordingly, the electronic device may control the operations of the components of the electronic device according to an operation process based on a growth condition of the basil stored in the memory, for example, the memory 830 of FIG. 8.

According to an example embodiment, the identification information providing unit of the cultivation box 120 may provide one image code that provides information for identifying a type of the seed 126 accommodated in each of the plurality of culture medium containers 122.

According to an example embodiment, the electronic device may include a moisture supplier (not shown) that supplies moisture for germination from a top of the culture medium. For example, when it is recognized that the culture medium cover 230 has been removed, the electronic device may transmit a signal to operate the pump connected to the pipe to supply the liquid through the pipe located at a top of a culture medium corresponding to the culture medium cover 230 as removed.

According to an embodiment, the electronic device may include at least one sensor that senses state information about the inside of the cultivation box 120 or around the cultivation box 120. For example, the electronic device may include a sensor (e.g., a connector) 521 connecting to the sensor receiving portion (the electrode) 127 of the cultivation box 120 for measuring the vertical level of the liquid inside the cultivation box 120. In another example, the electronic device may include a sensor which is inserted into the cultivation box through an opening of the cultivation box 120 and which measures at least one of a temperature and a humidity inside the cultivation box. In another example, the electronic device may include a sensor 522 that measures at least one of a temperature and a humidity around the cultivation box. For example, the sensor 522 may measure at least one of the temperature and the humidity within a specified distance from the cultivation box 120 or inside the cultivation box 120.

FIG. 6 is a diagram illustrating an example state in which the electronic device according to an embodiment, for example, the electronic device 110 of FIG. 1, the electronic device 801 of FIG. 8 sprays the liquid inside the cultivation box 120.

The cultivation box 120 may be sealed so that the inner space of the cultivation box 120 is separated from the outside of the cultivation box 120 in a state seated on the support 111. According to an embodiment, micro holes may be formed in a top of the cultivation box 120 to allow air to be supplied into the cultivation box 120.

When the cultivation box 120 is seated on the support 111, the nozzle 512 may be positioned to face the interior of the cultivation box 120. Further, a sensor 521 of the electronic device may be accommodated in the sensor receiving portion 127 of the cultivation box 120. Referring to FIG. 6, liquid 611 sprayed into the interior of the cultivation box 120 may sink into a space 612 formed in a bottom of the cultivation box 120 over time. The electronic device according to an example embodiment may include the sensor 521 for detecting a liquid vertical level in the space 612. The cultivation box 120 may include the sensor receiving portion 127.

According to an example embodiment, the electronic device may determine the growth state of a plant 600 grown from the seed based on the state information. For example, the sensor may be an image sensor included in the camera 114. The state information may be an image acquired through the image sensor. For example, the electronic device may determine whether the plant has germinated normally or whether a growth rate of the plant is within a normal range, based on the image acquired through the image sensor included in the camera 114.

According to an embodiment, the electronic device may control the components of the electronic device for controlling the growth environment of the cultivation box 120 based on the sensed state information. For example, the electronic device may control the driver to spray the liquid 611 into the cultivation box 120 through the pipe 511 and the nozzle 512 when the detected liquid vertical level is low. In another example, when it is determined that the growth rate of the plant is low, the electronic device may control the driver to spray a nutrient solution 611 inside the cultivation box 120.

According to an example embodiment, the electronic device may receive a user input. The electronic device may control the components of the electronic device for controlling the growth environment of the cultivation box 120 according to the user input. The electronic device may directly include an input device for receiving the user input, or receive the user input from another device having an input device via, for example, short-range wireless communication. According to an embodiment, the electronic device may receive the user input about a cultivation setting (e.g., a texture, taste, or aroma of the cultivated plant) of a cultivation target plant. The electronic device may control the components of the electronic device for controlling the growth environment according to the cultivation setting. For example, the electronic device may control the lamp (e.g., the lamp 115 of FIG. 2) according to a light amount, a wavelength of light, an operation duration, or an operation period of the lamp as preset in association with the cultivation setting.

According to an embodiment, the electronic device may control the components of the electronic device for controlling the growth environment of the cultivation box 120 based on the identification information obtained from the identifier providing means of the cultivation box 120. For example, the electronic device may determine, for example, and without limitation, the amount of light, the operation duration, the operation period of the lamp, for example, the lamp 115 in FIG. 2, that supplies light based on a type of the plant to be subjected to the cultivation as indicated by identification information, or the like. In another example, the electronic device may determine a spray amount, a spray time or a spray period of the liquid 611 based on a type of the plant to be subjected to the cultivation as indicated by the identification information.

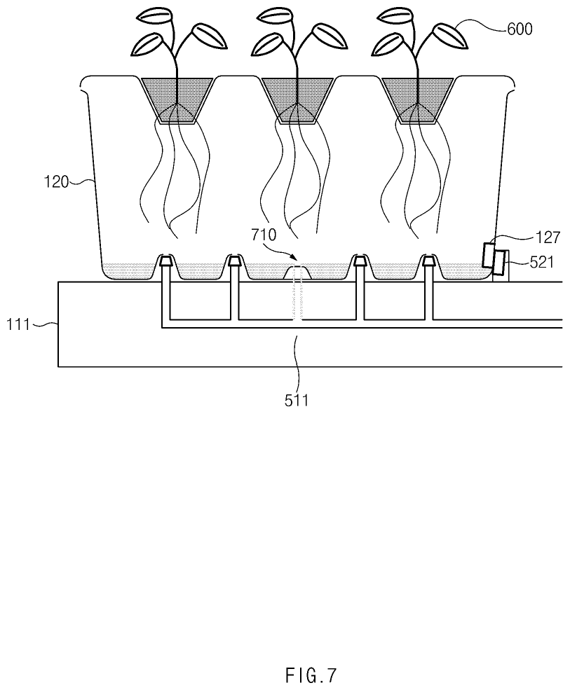

FIG. 7 is a diagram illustrating an example state in which an electronic device according to an example embodiment, for example, the electronic device 110 in FIG. 1 and the electronic device 801 in FIG. 8 stop spraying the liquid.

According to an embodiment, when the liquid vertical level inside the cultivation box 120 as detected through the sensor 521 is higher (e.g., greater) than or equal to a predefined level, the electronic device may control the operation of the driver to stop the liquid supply.

According to an example embodiment, the cultivation box 120 may include a drain 710 that allows the liquid to flow out when the vertical level of the liquid collected inside the cultivation box is above or equal to a specified level.

FIG. 8 is a block diagram illustrating an example electronic device in a network environment according to various embodiments.

FIG. 8 is a block diagram illustrating an electronic device 801 in a network environment 800 according to various embodiments. Referring to FIG. 8, the electronic device 801 in the network environment 800 may communicate with an electronic device 802 via a first network 898 (e.g., a short-range wireless communication network), or an electronic device 804 or a server 808 via a second network 899 (e.g., a long-range wireless communication network). According to an embodiment, the electronic device 801 may communicate with the electronic device 804 via the server 808. According to an embodiment, the electronic device 801 may include a processor 820, a memory 830, an input device 850, a sound output device 855, a display device 860, an audio module 870, a sensor module 876, an interface 877, a nozzle 879, a camera module 880, a power management module 888, a liquid supplier 889, a communication module 890, a support 896, or an antenna module 897. In some embodiments, at least one (e.g., the display device 860 or the camera module 880) of the components may be omitted from the electronic device 801, or one or more other components may be added in the electronic device 801. In some embodiments, some of the components may be implemented as single integrated circuitry. For example, the sensor module 876 (e.g., a fingerprint sensor, an iris sensor, or an illuminance sensor) may be implemented as embedded in the display device 860 (e.g., a display).

The processor 820 may execute, for example, software (e.g., a program 840) to control at least one other component (e.g., a hardware or software component) of the electronic device 801 coupled with the processor 820, and may perform various data processing or computation. According to an example embodiment, as at least part of the data processing or computation, the processor 820 may load a command or data received from another component (e.g., the sensor module 876 or the communication module 890) in a volatile memory 832, process the command or the data stored in the volatile memory 832, and store resulting data in a non-volatile memory 834. According to an embodiment, the processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or to be specific to a specified function. The auxiliary processor 823 may be implemented as separate from, or as part of the main processor 821.

The auxiliary processor 823 may control at least some of functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). According to an embodiment, the auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834.

The program 840 may be stored in the memory 830 as software, and may include, for example, an operating system (OS) 842, middleware 844, or an application 846.

The input device 850 may receive a command or data to be used by other component (e.g., the processor 820) of the electronic device 801, from the outside (e.g., a user) of the electronic device 801. The input device 850 may include, for example, a microphone, a mouse, a keyboard, or a digital pen (e.g., a stylus pen).

The sound output device 855 may output sound signals to the outside of the electronic device 801. The sound output device 855 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. According to an embodiment, the display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. According to an embodiment, the audio module 870 may obtain the sound via the input device 850, or output the sound via the sound output device 855 or an external electronic device (e.g., an electronic device 802) (e.g., speaker of headphone) directly (e.g., wiredly) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. According to an embodiment, the sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device (e.g., the electronic device 802) directly (e.g., wiredly) or wirelessly. According to an embodiment, the interface 877 may include, for example, a high definition multimedia interface (HDMI), a universal serial bus (USB) interface, a secure digital (SD) card interface, or an audio interface.

A connecting terminal 878 may include a connector via which the electronic device 801 may be physically connected with the external electronic device (e.g., the electronic device 802). According to an embodiment, the connecting terminal 878 may include, for example, a HDMI connector, a USB connector, a SD card connector, or an audio connector (e.g., a headphone connector).

The nozzle 879 may receive the liquid at one end thereof, and may spray the liquid at the other end thereof. According to an example embodiment, the nozzle 879 may be placed at a suitable location for receiving in a nozzle receiving portion of the cultivation box on support 896.

The camera module 880 may capture a still image or moving images. According to an embodiment, the camera module 880 may include one or more lenses, image sensors, image signal processors, or flashes.

The power management module 888 may manage power supplied to the electronic device 801. According to an example embodiment, the power management module 888 may be implemented as at least part of, for example, a power management integrated circuit (PMIC).

The liquid supplier 889 may supply the liquid to the nozzle 879 under the control of the processor 820. The liquid supplier 889 may include a pipe extending between a liquid supply source, for example, the liquid storage 116 shown in FIG. 1 or an external liquid supply pipe and the nozzle 879, and a driver for applying a pressure to allow the liquid supply to the nozzle 879.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the application processor (AP)) and supports a direct (e.g., wired) communication or a wireless communication. According to an embodiment, the communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as Bluetooth™ wireless-fidelity (Wi-Fi) direct, or infrared data association (IrDA)) or the second network 899 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other.

The antenna module 897 may transmit or receive a signal or power to or from the outside (e.g., the external electronic device) of the electronic device 801. According to an embodiment, the antenna module 897 may include an antenna including a radiating element including a conductive material or a conductive pattern formed in or on a substrate (e.g., PCB). According to an embodiment, the antenna module 897 may include a plurality of antennas. In such a case, at least one antenna appropriate for a communication scheme used in the communication network, such as the first network 898 or the second network 899, may be selected, for example, by the communication module 890 from the plurality of antennas. The signal or the power may then be transmitted or received between the communication module 890 and the external electronic device via the selected at least one antenna. According to an embodiment, another component (e.g., a radio frequency integrated circuit (RFIC)) other than the radiating element may be additionally formed as part of the antenna module 897.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 801 and the external electronic device 804 via the server 808 coupled with the second network 899. Each of the external electronic devices 802 and 804 may be a device of a same type as, or a different type, from the electronic device 801. According to an embodiment, all or some of operations to be executed at the electronic device 801 may be executed at one or more of the external electronic devices 802, 804, or 808. For example, when the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

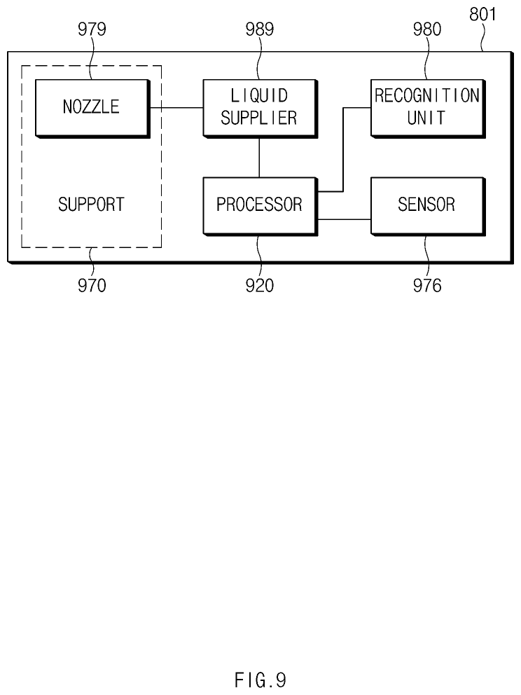

FIG. 9 is a block diagram illustrating an example configuration of the electronic device 801 according to an embodiment.

According to an example embodiment, the electronic device 801 may include a support 970, for example, the support 111 in FIG. 1 or the support 896 in FIG. 8, a nozzle 979, for example, the nozzle 512 in FIG. 6 or the nozzle 879 in FIG. 8, a liquid supplier 989, for example, the pipe 511 and the driver (not shown) in FIG. 6, or the liquid supplier 889 in FIG. 8, a sensor 976, for example, the sensors 521 and 522 in FIG. 5 or the sensor module 876 in FIG. 8, a recognition unit (e.g., including recognition circuitry) 980, and a processor (e.g., including processing circuitry) 920. The processor 920 may be operatively connected to the liquid supplier 989, the sensor 976, and the recognition unit 980. According to an example embodiment, the liquid supplier 989 may be connected to the nozzle 979 through the support 970.

The processor 920 may include various processing circuitry and execute instructions, for example, the instructions stored in the memory 830 of FIG. 8. When executing the instructions, the processor 920 may process data, and may control operations of the components of the electronic device 801 operatively connected to the processor 920.

The support 970 may be configured so that the cultivation box, for example, the cultivation box 120 of FIG. 1 may be seated thereon. The nozzle 979 may protrude toward a position where the cultivation box is seated on the support 970 so that the nozzle 979 may be inserted into the cultivation box as the cultivation box is seated on the support 970.

The liquid supplier 989 may include the driver (not shown) to supply the liquid to the nozzle 979 so that the liquid is sprayed from the nozzle 979. For example, the driver may include a pump that moves fluid under a pressure action. The driver may start or stop the operation according to a control signal transmitted from the processor 920.

The electronic device 801 may detect state information about the inside of the cultivation box and/or the surrounding area (e.g., within a specified distance) around the cultivation box using the sensor 976. The sensor 976 may transmit a sensed value to the processor 920. The processor 920 may acquire the state information based on the received value. The state information may include, for example, and without limitation, a temperature value inside or around the cultivation box, a humidity value inside or around the cultivation box, a liquid vertical level inside the cultivation box, a growth state of the plant, or the like. The sensor 976 may be configured according to a type of the state information to be acquired.

The processor 920 may acquire identification information using the recognition unit 980. According to various embodiments, the recognition unit 980 may include various recognition circuitry, such as, for example, a camera, for example, the camera 114 of FIG. 2 and the camera module 880 of FIG. 8. The processor 920 may recognize the image code marked on the cultivation box from the image acquired through the camera. The image code may refer, for example, to a code expressed in a form that the electronic device 801 may recognize, such as, for example, and without limitation, a one-dimensional code, for example, a bar code, and/or a two-dimensional code, for example, a QR code, or the like. From a result of recognizing the image code, the processor 920 may acquire identification information or location information (e.g., a uniform resource locator (URL)) in which the identification information is stored. When obtaining the location information in which the identification information is stored, the processor 920 may use a communication module, for example, the communication module 890 in FIG. 8 to access the identification information stored in the location information.

According to another embodiment, the recognition unit 980 may include an RFID reader for reading RFID. The RFID reader may transmit an RF signal for reading the RFID tag. When the RFID tag included in the cultivation box is located within a range of the RF signal from the RFID reader, the RFID reader may receive RFID from the RFID tag.

The recognition unit 980 may be configured in various forms. For example, the recognition unit 980 may include a connector, and may connect with the cultivation box through the connector to receive the identification information therefrom.

The processor 920 may determine (or, identify) an operation state of the driver based on at least one of the state information and the identification information in a state where the cultivation box is seated on the support 970. According to an embodiment, the processor 920 may determine, for example, and without limitation, an operation period, an operation time, an operation intensity (e.g., an operation voltage value or an operation current value) of the driver, or the like, based on the identification information. For example, when the processor 920 determines that the obtained identification information is an ID indicating the basil, the processor 920 may obtain an operation sequence of the driver stored in the memory of the electronic device, for example, the memory 830 in FIG. 8 or the external device, for example, the electronic device 802, the electronic device 804, or the server 808 in association with the ID of the basil. The processor 920 may control the operation of the driver based on the obtained operation sequence.

According to an embodiment, the processor 920 may determine whether to operate the driver based on the state information. For example, when the liquid vertical level obtained through the sensor 976 exceeds a threshold, the processor 920 may stop the operation of the driver. In another example, the processor 920 may recognize the growth state of the plant from the image acquired through the sensor, and may determine a value corresponding to the recognized growth state. The processor 920 may determine whether a value representing the growth state of the plant is present in a specified range. When the value representing the growth state is smaller than a minimum value of the specified range, the processor 920 may control the operation of the driver so that an additional nutrient solution is supplied to the plant.

According to an example embodiment, the processor 920 may control the operation of the driver based on the user input. For example, the electronic device 801 may receive a command regarding the operation of the driver from the input device, for example, the input device 850 in FIG. 8, or the external device, for example, the electronic device 802, the electronic device 804, or the server 808. The electronic device 801 may receive a command from an external device via a short-range communication module of the electronic device, for example, the wireless communication module 892 in FIG. 8. The processor 920 may execute the received command to control the operation of the driver.

According to an embodiment, the processor 920 may determine the growth state of the plant to be cultivated using the cultivation box, based on the state information. The processor 920 may acquire the image using the sensor 976 or the image sensor of the camera. The processor 920 may recognize the image of the plant included in the acquired image, and may analyze the image of the plant to determine the growth state thereof. The processor 920 may extract feature information from the image, and may determine the growth state using a program that recognizes and analyzes the image based on the feature information. The growth state may be including a value of at least one parameter. For example, the growth state may include, for example, and without limitation, at least one of a leaf size, a stem color, a number of leaves, a leaf color, or the like, as parameters.

According to an embodiment, the processor 920 may output information corresponding to the growth state as determined, using the information output device, for example, the sound output device 855, the display 860, and the communication module 890 of FIG. 8. For example, the processor 920 may control the electronic device 801 to display a screen including an image or a text related to the growth state on the display. In another example, the processor 920 may transmit the information related to the growth state via a communication module to the external device, for example, the electronic device 802, the electronic device 804, or the server 808. According to an embodiment, the processor 920 may search for the information related to the growth state stored in the memory of the electronic device 802 or the external device, based on the parameter included in the growth state.

According to an embodiment, the processor 920 may determine whether the determined growth state is out of a specified range. The specified range may refer, for example, to a range in which a value of each parameter included in the growth state belongs to when the plant normally grows. The growth state being outside the specified range may refer, for example to the plant not having grown normally.

When the plant does not grow normally, for example, when the seed does not germinate normally, this may refer, for example, to a normal product not being provided from a provider to a buyer who has purchased the cultivation box. When a normal seed is not provided to the buyer, it is necessary for the provider to provide a new cultivation box to the buyer again. However, a process in which the buyer informs the provider that germination has not been properly performed, and requests a new cultivation box to the provider of the previous cultivation box may cause inconvenience to the buyer. The electronic device 801 according to an embodiment may acquire coupon information for providing the cultivation box in order to allow the purchaser to receive a new cultivation box easily. The coupon information may be related to identification information about a seed whose a growth state is determined to be out of the specified range. The electronic device 801 may transmit a coupon issuance request including the identification information to a management server, for example, the server 808 in FIG. 8, via the communication module, thereby to obtain the coupon information. In response to the coupon issuance request, the electronic device 801 may receive the coupon information from the management server via the communication module. The electronic device 801 may provide the obtained coupon information to the buyer. For example, the electronic device 801 may output a screen including the coupon information on the display of the electronic device 801 or register the coupon information into a user account of the buyer.

According to an embodiment, the electronic device 801 may further include the camera, for example, the camera 114 of FIG. 2 and the camera module 880 of FIG. 8. The electronic device 801 may acquire an image of a surface on which at least one culture medium cover of the cultivation box is disposed using the camera. The processor 920 of the electronic device 801 may analyze the captured image to determine an open or close state of the at least one culture medium cover. The processor 920 may control the operation state of the driver based on the determined open or close state. For example, the cultivation box has a first culture medium cover, a second culture medium cover, a third culture medium cover and a fourth culture medium cover. First to fourth identifiers having first identification information, second identification information, third identification information, and fourth identification information respectively may be marked on the first to fourth culture medium covers, respectively. In this connection, when it is determined that the first culture medium cover and the second culture medium cover are open, the processor 920 may control an operation state of an environment control device for controlling the growth environment of the cultivation box of the electronic device, based on the first identification information and the second identification information. The environment control device may include, for example, the driver of the liquid supplier 989, a device for temperature adjustment, for example, a heater, a fan for air circulation, or a lamp for irradiating light to the plant, for example, the lamp 115 in FIG. 2.

According to an embodiment, the processor 920 may determine whether the nozzle 979 has failed. For example, when it is detected that liquid is not sprayed through the nozzle 979 even though the processor 920 controls the driver to operate, the processor 920 may determine that failure has occurred in the nozzle 979. When the processor 920 determines that the failure has occurred in the nozzle 979, the processor 920 may stop the operation of the driver.

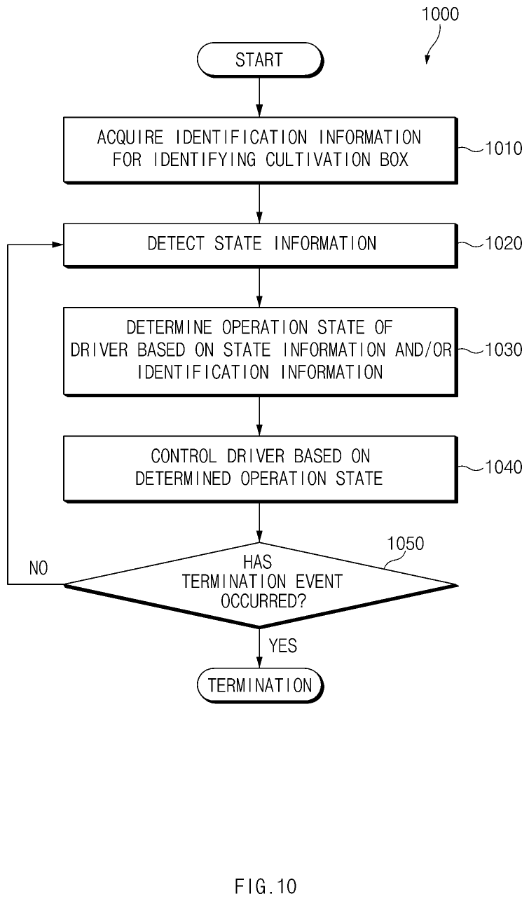

FIG. 10 is a flowchart 1000 illustrating an example operation of an electronic device according to an embodiment, for example, the electronic device 110 of FIG. 1, the electronic device 801 of FIG. 8, the electronic device 801 of FIG. 9.

According to an embodiment, the electronic device may obtain (e.g., acquire) the identification information identifying the cultivation box as the cultivation box is seated on the electronic device in operation 1010. The identification information may indicate information capable of identifying a seed accommodated in the culture medium container of the cultivation box. In an embodiment in which the image code for providing the identification information is marked on one surface of the culture medium cover, the electronic device may acquire the identification information corresponding to the culture medium cover attached to the cultivation box. In an embodiment in which the image code for providing the identification information is marked on a position screened with the culture medium cover attached to the cultivation box, the electronic device may acquire the identification information corresponding to the opened culture medium cover.

In operation 1020, the electronic device may detect the state information about the environment related to the plant growth of the cultivation box. The electronic device may collect values sensed from at least one sensor of the electronic device to obtain the state information.

In operation 1030, the electronic device may determine (or, identify) the operation state of a driver that supplies the liquid to the nozzle spraying the liquid into the cultivation box, based on at least one of the identification information and/or the state information. For example, the electronic device may determine the operation period, the operation time, or the operation intensity (for example, the operation voltage value or the operation current value) of the driver, based on the identification information. According to an example embodiment, the electronic device may determine whether to operate the driver, based on the state information. For example, when the liquid vertical level obtained through the sensor exceeds a threshold, the electronic device may stop the operation of the driver. In another example, the electronic device may recognize the growth state of the plant from the image acquired through the sensor, and may determine a value corresponding to the recognized growth state. The electronic device may determine whether a value representing the growth state of the plant is present within a specified range. When the value representing the growth state is smaller than a minimum value of the specified range, the electronic device may control the operation of the driver so that an additional nutrient solution is supplied to the plant.

In operation 1030, the electronic device may determine (or, identify) the operation state of the environment control device (a device for controlling the growth environment of the cultivation box) other than the driver. The environment control device may include, for example, a device for temperature adjustment, for example, a heater, or a fan for air circulation, or a lamp for irradiating light to the plant, for example, the lamp 115 of FIG. 2.

According to an example embodiment, in operation 1030, the electronic device may determine whether the culture medium cover of the cultivation box is opened. The electronic device may use only the identification information corresponding to the open culture medium cover to determine the operation state of the driver.

According to an example embodiment, in operation 1030, the electronic device may determine the growth state of the plant being cultivated using the cultivation box, based on the state information. The electronic device may determine an operation to be performed by the electronic device, based on the determined growth state. For example, when the plant growth state is outside a normal range, the electronic device may perform an operation of outputting the coupon information or transmitting information requesting of the cultivation box again together with the identification information to the management server.

In operation 1040, the electronic device may perform the operation determined in operation 1030. According to an example embodiment, the electronic device may control the driver based on the determined operation state. Alternatively, the electronic device may control the operation state of the environment control device.

In operation 1050, the electronic device may determine whether a termination event has occurred. The termination event may refer, for example, to an event that terminates the process of controlling the environment for the growth of the cultivated plant using the cultivation box. For example, the electronic device may determine whether the growth state of the plant is in a range indicating that the growth is completed. When the growth state of the plant is in the range indicating that the growth is completed, the electronic device may determine that the termination event has occurred. In another example, the electronic device may receive a user input commanding the termination of the plant cultivation through the input device. The electronic device may determine the reception of the user input commanding the termination as the occurrence of the termination event. When no termination event occurs (“No” in operation 1050), the electronic device may repeat the operations 1020, 1030, 1040 and 1050.

According to an example embodiment, when the termination event occurs, the electronic device may stop the operation of the environment control device. According to another embodiment, when the termination event occurs, the electronic device may control the operation of the environment control device based on an operation program that provides the environment in which the growth state of the plant is maintained. When the termination event occurs, the electronic device may output a message indicating that harvesting of the plant is available. When the termination event occurs, the electronic device may search for a recipe based on the identification information of the cultivation box where the growth of the plant has been completed. Then, the electronic device may output the searched recipe through the output device of the electronic device or through the external device.

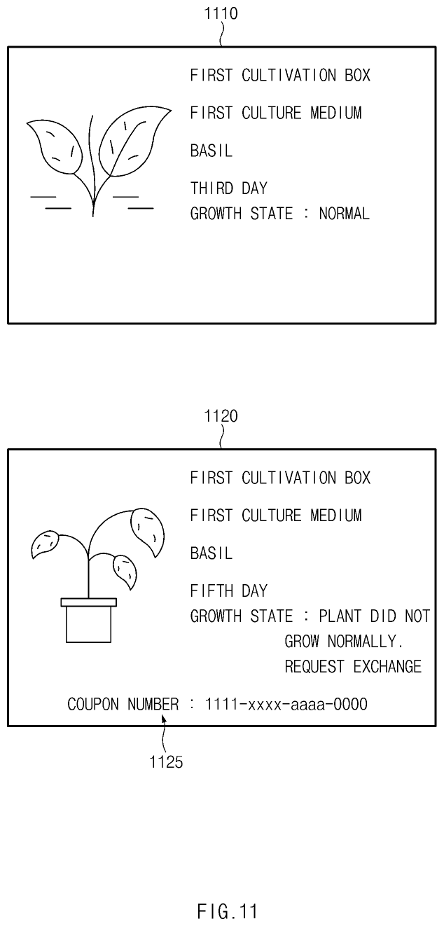

FIG. 11 is a diagram illustrating an example screen 1110 or 1120 output according to an embodiment.

The screen 1110 or 1120 illustrated in FIG. 11 may be displayed on the display of the electronic device or may be displayed on an external device connected to the electronic device.

When the growth state determined based on the state information obtained by the electronic device is present in the normal range, the screen 1110 including growth state guide information to guide the growth state of the plant may be displayed.

When the growth state determined based on the state information obtained by the electronic device is out of the normal range, the screen 1120 including information indicating that the plant growth has failed may be displayed. According to an example embodiment, the screen 1120 may include coupon information 1125 that may be used for exchange of the cultivation box.

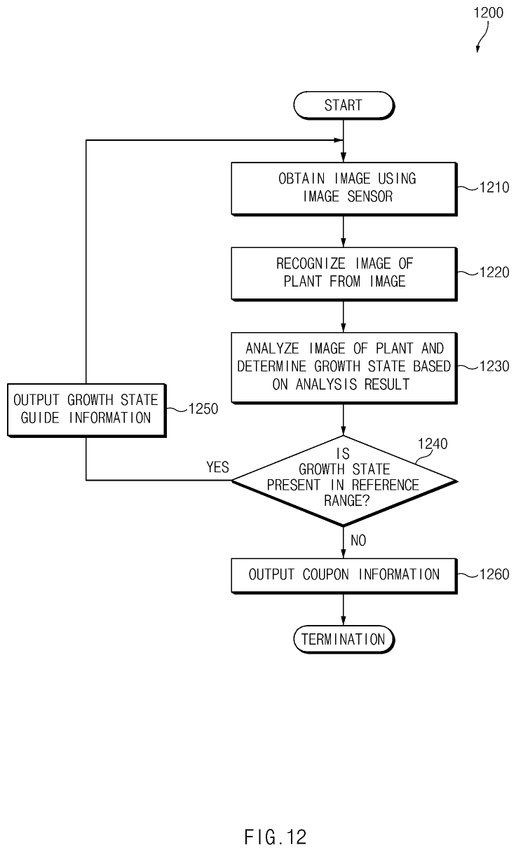

FIG. 12 is a flowchart 1200 illustrating an example process in which an electronic device according to an embodiment, for example, the electronic device 110 of FIG. 1, the electronic device 801 of FIG. 8, the electronic device 801 of FIG. 9 monitors the growth state of the plant.

According to an embodiment, the electronic device may acquire (e.g., obtain) the image captured through the image sensor in operation 1210. In operation 1220, the electronic device may recognize the image of the plant from the image obtained via object recognition of the image.

In operation 1230, the electronic device may determine the growth state for the plant under cultivation based on an analyzing result of the image as recognized. According to an example embodiment, the electronic device may set the growth state of the plant as a value of at least one parameter.

In operation 1240, the electronic device may determine whether the determined value of the growth state is present in a reference range. The reference range may refer to a range in which each parameter included in the growth state is expected to be present when the plant is normally grown.

When the value of the growth state is present in the reference range (“Yes” in operation 1240), the electronic device may output the growth state guide information indicating the growth state of the plant in operation 1250. According to an example embodiment, in operation 1250, the electronic device may display a screen including the growth state guide information on the display of the electronic device. According to another embodiment, in operation 1250, the electronic device may output the growth state guide information through the external device.

When the value of the growth state is out of the reference range (“No” in operation 1240), the electronic device may output the coupon information for the exchange of the cultivation box in operation 1260. According to an example embodiment, the electronic device may transmit the identification information of the plant that has not been normally grown to the management server, and may obtain the coupon information corresponding to the identification information from the management server.

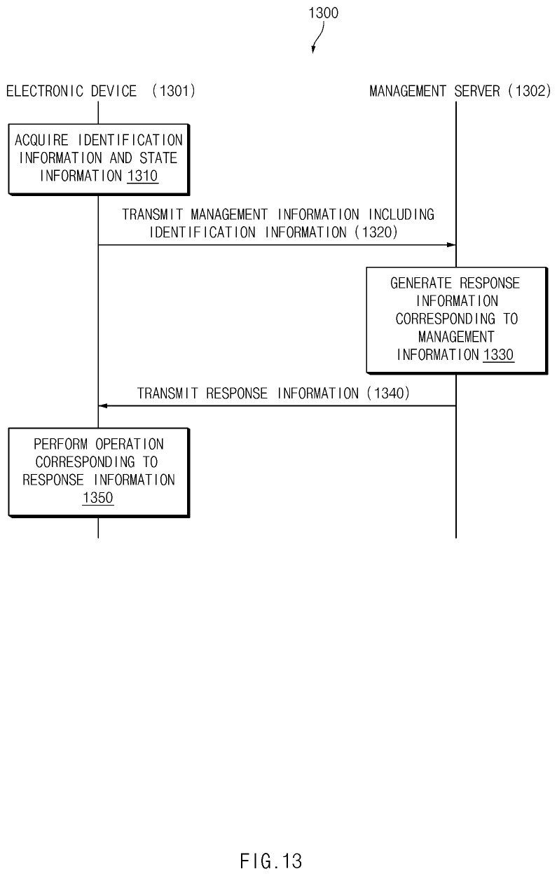

FIG. 13 is a signal flow diagram 1300 illustrating an example operation process of the cultivation system including a management server 1302, for example, the server 808 of FIG. 8 according to an embodiment.

According to an example embodiment, in operation 1310, the electronic device 1301 may acquire the identification information and the state information about the cultivation box seated on the electronic device 1301. In operation 1320, the electronic device 1301 may transmit management information including the identification information to the management server 1302. In operation 1330, the management server 1302 may generate response information corresponding to the management information. In operation 1340, the management server 1302 may transmit the generated response information to the electronic device 1301. In operation 1350, upon receiving the response information, the electronic device may perform an operation corresponding to the response information.

According to an example embodiment, the management information may include the identification information and the state information. The response information generated in operation 1330 may include a control command for controlling the components of electronic device 1301 based on the identification information and the state information. For example, the identification information may be information indicating cabbage. In this case, the temperature information suitable for the growth of the cabbage stored in the management server 1302 may be 28 degrees C. Thus, when the temperature information included in the state information is 20 degrees C., the management server 1302 may generate the response information including a control command to supply power to a heating element of the electronic device 1301. In operation 1350, the electronic device may control a power management module, for example, the power management module 888 of FIG. 8 to supply the power to the heating element based on the response information.

According to an example embodiment, the management information may include the coupon issuance request. In operation 1310, the electronic device 1301 may determine whether the plant has grown normally based on the identification information and the state information. When it is determined that the plant does not grow normally, that is, grows abnormally, the electronic device 1301 may transmit the coupon issuance request including the identification information to the management server 1302 in operation 1320. In operation 1330, the management server 1302 may generate the response information including the coupon information for exchanging the cultivation box corresponding to the identification information. When the management server 1302 transfers the response information to the electronic device 1301 in operation 1340, the electronic device 1301 may output the coupon information in operation 1350.

The cultivation system according to various example embodiments of the disclosure may be configured using various types of electronic devices. In this case, the electronic device may include, for example, a device combined with a water purifier, a device combined with a refrigerator, a device configured in a form of a sink drawer, or a system including of an independent cultivation device. The electronic device according to an embodiment of the disclosure is not limited to the aforementioned devices.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 840) including one or more instructions that are stored in a storage medium (e.g., internal memory 836 or external memory 838) that is readable by a machine (e.g., the electronic device 801). For example, a processor (e.g., the processor 820) of the machine (e.g., the electronic device 801) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to example embodiments of the disclosure, a cultivation system, a cultivation box, and a control method thereof to allow a user to easily replace a cultivation target plant and to cultivate the same may be provided.

According to example embodiments of the disclosure, a cultivation system, a cultivation box, and a control method thereof, in which a cultivated plant may be automatically recognized and, thus, environment conditions may be controlled according to a type of the plant may be provided.

According to example embodiments of the disclosure, a cultivation system and a control method thereof to enable a user to easily obtain a new seed product when the current plant does not grow normally may be provided.

In addition, various effects that may be directly or indirectly identified from the disclosure may be provided.

While the disclosure has been illustrated and described with reference to various example embodiments thereof, it will be understood that the various example embodiments are intended to be illustrative, not limiting. It will be further understood by those skilled in the art that various changes in form and details may be made therein without departing from the true spirit and full scope of the disclosure, including the appended claims and their equivalents.

What is claimed is:

1. An electronic device comprising:
a support configured to support a cultivation box for cultivation of a plant;
a nozzle configured to be inserted into the cultivation box based on the cultivation box being seated on the support;
a liquid supplier configured to spray liquid into the cultivation box through the nozzle;
a sensor configured to detect state information inside or around the cultivation box;
a recognition circuitry configured to acquire identification information identifying the cultivation box from the cultivation box based on the cultivation box being seated on the support; and
a processor connected to the liquid supplier, the sensor, and the recognition circuitry,
wherein the processor is configured to:
identify an operation state of the liquid supplier based on the state information and the identification information based on the cultivation box being seated on the support; and
control the liquid supplier to spray the liquid into the cultivation box based on the identified operation state.

2. The electronic device of claim 1, wherein the recognition circuitry includes a camera,
wherein the processor is configured to:
recognize an image code from an image acquired using the camera; and
acquire the identification information using the image code.

3. The electronic device of claim 1, wherein the recognition circuitry includes an RFID (radio frequency identification) reader comprising circuitry configured to read an RFID, wherein the identification information includes RFID information.

4. The electronic device of claim 1, wherein the sensor includes at least one of:
a liquid vertical level sensor configured to detect a vertical level of the liquid contained in the cultivation box;
a first temperature sensor inserted into the cultivation box based on the cultivation box being coupled to the electronic device, wherein the temperature sensor is configured to measure a temperature of an inside of the cultivation box; or
a second temperature sensor configured to measure a temperature around the cultivation box.

5. The electronic device of claim 1, wherein the processor is configured to:
determine a growth state of the plant based on the state information; and
perform an operation corresponding to the growth state.

6. The electronic device of claim 5, wherein the sensor includes an image sensor,
wherein the processor is configured to:
recognize an image of the plant from an image acquired using the image sensor; and
analyze the image of the plant and determine the growth state based on the analysis.

7. The electronic device of claim 5, further comprising information output circuitry,
wherein the processor is configured to control the information output circuitry to output information corresponding to the growth state.

8. The electronic device of claim 7, wherein based on the growth state being outside a specified range, the electronic device is configured to output coupon information corresponding to the identification information.

9. The electronic device of claim 8, further comprising a communication module comprising communication circuitry configured to communicate with a management server,
wherein based on the growth state being outside the specified range, the processor is configured to control the electronic device to transmit a coupon issuance request including the identification information to the management server via the communication module,
wherein the processor is configured to control the electronic device to receive the coupon information corresponding to the identification information from the management server via the communication module.

10. The electronic device of claim 1, further comprising a short-range communication module comprising short-range communication circuitry configured to communicate with an external electronic device,
wherein the processor is configured to control an operation state of the liquid supplier based on a command received from the external electronic device via the short-range communication module.

11. The electronic device of claim 1, further comprising a camera,
wherein the processor is configured to:
analyze an image obtained using the camera and determine an open or close state of each of at least one culture medium cover of the cultivation box, based on the analysis; and
control an operation state of the liquid supplier based on the determined open or closed state.

12. The electronic device of claim 1, further comprising a lamp or temperature adjustment unit comprising temperature adjustment circuitry,
wherein the processor is configured to control power to be supplied to the lamp or the temperature adjustment unit based on the state information and the identification information.

13. A cultivation box for plant cultivation, the cultivation box comprising:
an identifier comprising readable identification information configured to identify the cultivation box; and
a housing having an inner space blocked from an outside,
wherein the housing includes:
a culture medium container provided in a top of the housing and accommodating a culture medium in the container;
a nozzle receiving portion accommodating a nozzle based on the cultivation box being seated on an electronic device having the nozzle; and
a sensor receiving portion accommodating a sensor of the electronic device.

14. The cultivation box of claim 13, wherein the identifier is disposed on a culture medium cover covering a top of the culture medium container.

15. The cultivation box of claim 14, wherein the identifier includes an image code marked on one surface of the culture medium cover.

16. The cultivation box of claim 13, wherein the identifier includes an RFID (radio frequency identification) tag.

17. A plant cultivation system comprising:
a replaceable cultivation box including a housing, and identification information of the cultivation box; and
an electronic device configured to:
acquire the identification information from the cultivation box;
detect state information about an inside of the cultivation box or around the cultivation box using a sensor; and
spray liquid into the cultivation box based on the identification information and the state information.

18. The plant cultivation system of claim 17, wherein the cultivation box includes an image code including the identification information, wherein the image code is provided on an outer surface of the cultivation box,
wherein the electronic device is configured to acquire the identification information using the image code from an image captured using a camera.

19. The plant cultivation system of claim 17, further comprising a management server,
wherein the electronic device is configured to:
transmit the state information to the management server; and
receive an operation command corresponding to the state information from the management server and execute the command.

20. The plant cultivation system of claim 17, wherein the sensor includes an image sensor,
wherein the electronic device is configured to:
recognize an image of a plant based on an image acquired using the image sensor; and
analyze the image of the plant and determine a growth state of the plant based on the analysis.
